(19) United States
(12) Patent Application Publication
(10) Pub. No.: US 2008/0078110 A1
(43) Pub. Date: Apr. 3, 2008

(54) Robotic sign waver

(76) Inventor: Bob Scheef Christian, Orange, CA (US)

Correspondence Address: BOB S. CHRISTIAN, 5611 E. MOUNTAIN AVENUE, ORANGE, CA, 92867, US

(21) Appl. No.: 11/389,583

(22) Filed: Oct. 2, 2006

(51) Int. Cl. G09F 19/08

(52) U.S. Cl. 40/419

(57) ABSTRACT

The robotic sign waver is unique in the use of common technologies used in an uncommon way. The industrial electric motor driving an eccentric cam that moves a bar has been used in various applications over the years. My patent request is the application of this technology to serve new and necessary purposes.

### BACKGROUND OF INVENTION

This machine is designed as a lower cost advertising tool for current users of human sign wavers. The act of continuously waving a sign, in all kinds of weather, for minimum wage, I feel should be phased out for humane reasons.

### SUMMARY OF INVENTION

I have invented a machine to replace people currently hired to stand at street corners who swing signs promoting various businesses. This machine imitates the motions of a human waver and can operate for 40 hours without recharging. The primary benefit is a cost savings to businesses which now hires workers at $8 dollars per hour. Machine rentals are only $25. per day or $100. per seven day week. The machine also requires no breaks or benefits, and can work all day without fatigue.

### DESCRIPTION OF DRAWINGS

FIG. 1 Shows the front view of the base which houses all the robotic equipment and wiring. The signs are mounted to a 36″ bar which is driven in a14″ elliptical pattern, at 50 swings per minute. A precision ball bearing slide gives quiet operation and long life.

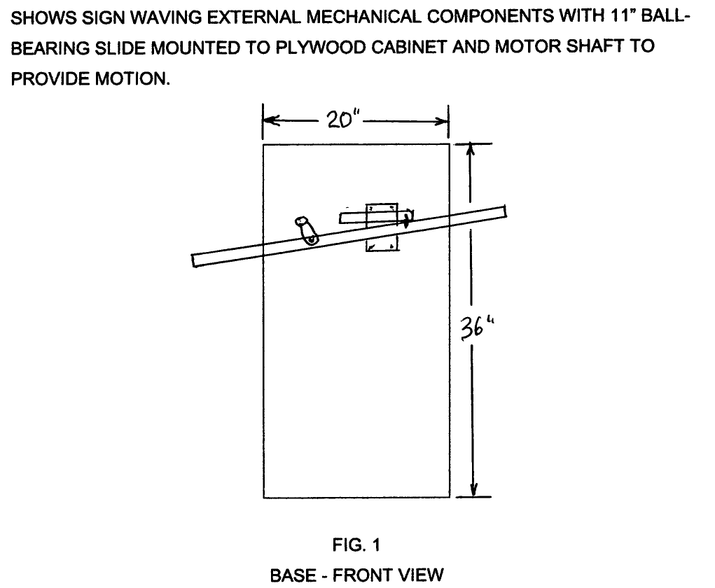

FIG. 2 Shows the rear view of the base, with the electrical plug for the battery charger.

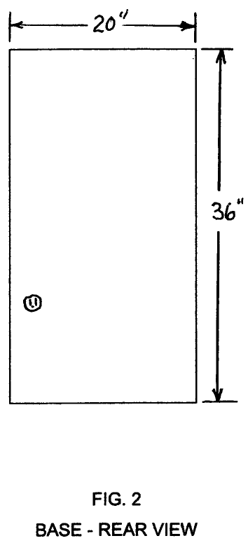

FIG. 3 Shows the left side view of the base.

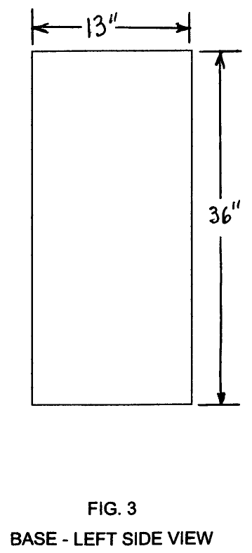

FIG. 4 Shows the right side view of the base.

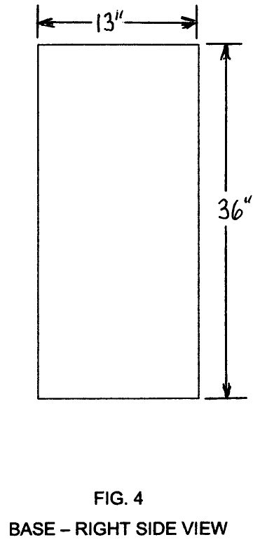

FIG. 5 Shows the top view of the base with the on/off switch and the circuit breaker.

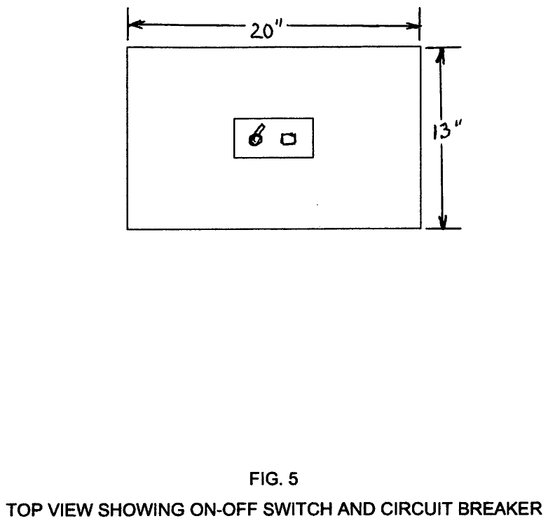

FIG. 6 Shows the bottom view on the base with four anti-slip rubber pads mounted at the corners.

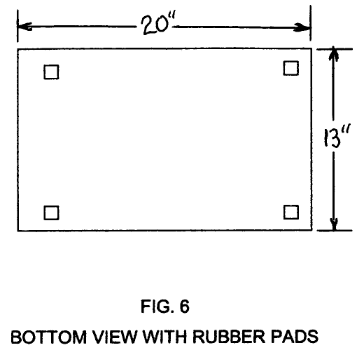

FIG. 7 Shows a representation of the life-like robot that is mounted on top of the base. Also offered are Clowns, Cheerleaders, Athletes, Santa Claus and Cartoon Characters. The Safety Robot construction worker is painted in a high-visibility orange complete with hard hat. He is designed for road crews to prevent injuries to workers. Arms are clamped to the moving sign for realistic movement

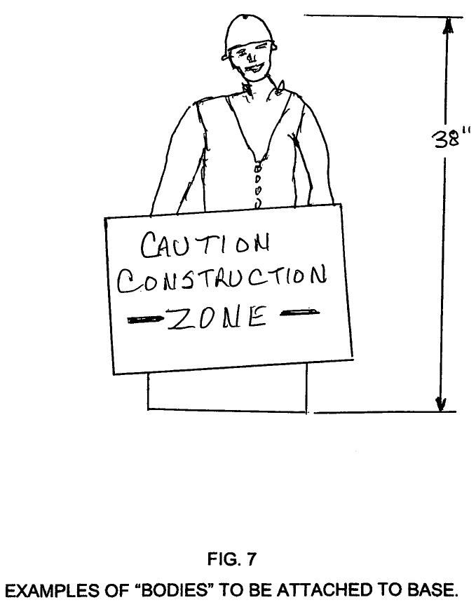

FIG. 8 Show the rear view with the rear cover removed. It houses the high torque industrial gear motor, the battery charger and the deep cycle 12 volt battery and required wiring.

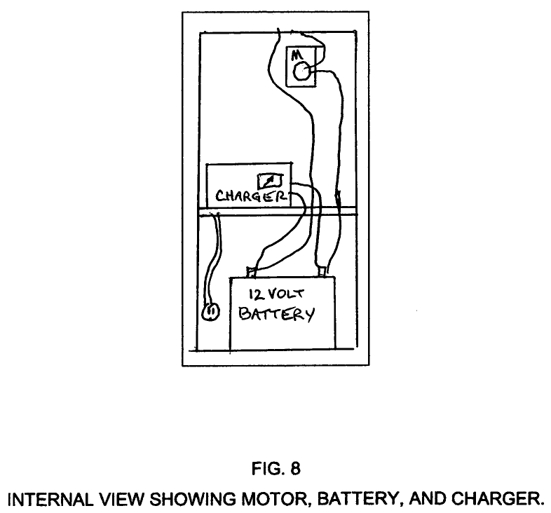

### DETAILED DESCRIPTION OF THE INVENTION

This invention was born while watching a human sign waver working in the sun on a 100+degree day. I thought there must be a better way. The result is a fully functional, tested and field proven device to reduce the number of people that need to do this, while saving the advertisers significant dollars. The parts required to make this came through much trial and error. Finding the right combination of speed, torque, distance and battery life were key to having a viable product.

The use of this invention is quite simple. It is delivered in two parts for ease in shipping. The robot top simply fastens to the base with wing nuts and then the robot's arms are clamped to the sign. The only thing the user needs to do is turn it on, and every 40 hours recharge the battery by simply plugging the base into a receptacle overnight.

1. I claim this invention is mine and that no such robotic sign waver has been made or used before. This claim is for any self-contained motorized device that waves signs in a human-like manner for advertising or safety reasons.
